(19) United States
(12) Patent Application Publication
(10) Pub. No.: US 2003/0020389 A1
(43) Pub. Date: Jan. 30, 2003

(54) Electron gun for cathode ray tube

(75) Inventor: Dae-Sik Hwang, Gyeongsangbuk-Do (KR)

Correspondence Address: FLESHNER & KIM, LLP, P.O. Box 221200, Chantilly, VA, 20153-1200, US

(73) Assignee: LG Philips Displays Co., Ltd.

(21) Appl. No.: 10/201,083

(22) Filed: Jul. 24, 2002

(30) Foreign Application Priority Data
Jul. 25, 2001 (KR) 44873/2001
Apr. 29, 2002 (KR) 23428/2002

(51) Int. Cl. H01J 29/70

(52) U.S. Cl. 313/427

(57) ABSTRACT

An electron gun for a CRT having a cathode for discharging electron beams, a first electrode for controlling the electron beams discharged from the cathode, and a second electrode for accelerating the electron beams having passed the first electrode, third, fourth and fifth electrodes sequentially installed in the direction of a screen and serving as a pre-focus lens, in which an electron beam passing hole of the third electrode, an electron beam passing hole of the fourth electrode and an electron beam passing hole of the fifth electrode have different sizes By controlling the size of the electron beam passing hole of the third the fourth and the fifth electrodes, the divergence angle and the electron beam size are reduced and the spherical aberration is also reduced Accordingly, a degradation of the spot focussed on the screen can be effectively prevented.

### BACKGROUND OF THE INVENTION

1. Field of the Invention

The present invention relates to a cathode ray tube, and more particularly, to an electron gun for a cathode ray tube that is capable of reducing an increase in size of a spot when the size of spot is changed as a current and a focus voltage is changed in a cathode ray tube using a high current.

2. Description of the Background Art

In general, a cathode ray tube includes: an in-line electron gun for discharging three electron beams; a deflection yoke for deflecting the electron beams to a determined place of a screen, a shadow mask for aligning the electron beams; and a screen for reproducing an image as the electron beams collide with thereon.

A Japanese Patent Publication No. 60-51775 discloses that when a beam current is increased, a general electron beam spot is enlarged, and thus, in order to obtain a distinct image, the beam current should be maintained at a small value if possible.

The Japanese Patent discloses that in case of a CRT in which a high current is to be used, since the variation range of the current is wide, a uni-bi potential main lens structure should be adapted, which has improved a pre-focus lens in the general bi-potential main lens structure, in order to reduce the increase in the spot size on the screen.

The Japanese Publication has a construction that it includes a first electrode, a second electrode, a third electrode and a fourth electrode. The third electrode is divided into three sections of a platy 3-1 electrode, a plane-shaped 3-2 electrode and a cylindrical 3-3 electrode.

The 3-2 electrode and the 3-3 electrode have the same size of electron beam passing holes, while the 3-1 electrode has a smaller electron beam passing hole than that of the 3-2 electrode and 3-3 electrode.

An electron gun for a CRT in accordance with the conventional art similar to the Japanese Publication will now be described with reference to the accompanying drawings.

In general, the electron gun discharges three electron beams (R, G and B), and FIG. 1 shows generation of one electron beam and its movement path.

As shown in FIG. 1, an electron gun for a CRT includes: a cathode (K) for discharging electron beams, a first electrode 1 (grid) for controlling the electron beams discharged from the cathode (K); a second electrode 2 for accelerating the electron beams which have passed the first electrode 1; third, fourth and fifth electrons 3, 4 and 5 for focussing the electron beams; and a sixth electrode 6, an anode, for receiving a high voltage.

The operation of the electron gun will now be described.

First, when a heater (not shown) inserted in the cathode (K) heats the cathode, electron beams are radiated from an oxide (not shown) coated on the surface of the cathode (K).

The thusly radiated electron beams are controlled by the first electrode 1, the control electrode, accelerated by the second electrode (2), and focussed by third, fourth, fifth and sixth electrodes (3, 4, 5 and 6).

Meanwhile, when a high current is generated from the electron gun, a current density of a cross over is not increased as high as a beam current value is increased on account of a space charge repulsion effect, In addition, since the current density distribution is close to a flat and even distribution, not shoeing a Gaussian distribution, so that the cross over is degraded.

When the cross over is degraded, the spot on the screen shows degraded characteristics.

Thus, in order to improve the degradation of the cross over, a voltage of the cross over should be increased to reduce the space charge repulsion effect.

In order to increase the voltage of the cross over, there are many methods, and generally, the third electrode 3 is moved to the second electrode 2 to increase the voltage of the cross over, thereby reducing the space charge repulsion effect.

As a result, however, a divergence angle (α) is increased only to increase the size (Db) of the electron beam in a main lens.

That is, as shown in FIGS. 7A, 7B, 8A and 8B, when the size (Db) of electron beam is increased at the main lens, a spherical aberration is increased, which causes an increase of the spot on the screen.

In order to improve the problem, the divergence angle (α) after the cross over should be reduced. In this respect, however, since the cross over is moved beyond the second electrode 2 (toward the sixth electrode) at a high current, it is difficult to improve the divergence angle (α) only with the construction of the third, fourth and fifth electrodes 3, 4 and 5.

In addition, in order to reduce the divergence angle (α) after the cross over, another pre-focus lens may be additionally installed between the pre-focus lens and the main lens formed by the second electrode 2 and the third electrode 3.

Referring to a formation of the pre-focus lens, as shown in FIG. 1, a focusing electrode is divided into a third electrode 3, a fourth electrode 4 and a fifth electrode 5, to which the same voltage is applied to thereby make them to have a uni-potential lens type.

In forming the pre-focus lens, the size of an electron beam passing hole 41 of the fourth electrode 4 is the same as the size of an electron beam passing hole 51 of the fifth electrode 5, facing the fourth electrode 4, and the size of the electron beam passing hole 41 of the fourth electrode is greater than that of the third electrode electron beam passing hole 31.

By doing that, the divergence angle (α) of the electron beam made incident on the main lens is reduced, and accordingly, the size (Db) of the electron beam on the main lens is reduced.

In addition, as the size (Db) of the electron beam of the main lens is reduced, a spherical aberration is reduced, resulting in that the spot on the screen is improved.

However, the conventional electron gun has the following problems.

That is, in the conventional electron gun, in order to adjust the divergence angle (α) of the electron beam, the fourth electrode should be formed platy in the pre-focus lens of the front end of the main lens and installed closely in the third electrode direction, and the fifth electrode should be installed close to the fourth electrode.

Meanwhile, in the construction of the pre-focus lens, the size 41 of the electron beam passing hole of the fourth electrode is the same as that of the electron beam passing hole 51 of the fourth electrode of the fifth electrode.

In such a case, design factors for controlling the divergence angle (α) are limited to thickness of the third electrode 3, the fourth electrode 4, the fifth electrode, a space d1 between the third electrode 3 and the fourth electrode 4, a space d2 between the fourth electrode 4 and the fifth electrode 5, a nominal size of the electron beam passing hole 51 of the third electrode 3, the electron beam passing hole 41 of the fourth electrode 4 and the electron beam passing hole 51 of the fifth electrode 5

As a result, in order to additionally adjust the divergence angle (α), an auxiliary electrode needs to be added between the second, third and fourth electrodes, and their construction is complicated.

### SUMMARY OF THE INVENTION

Therefore, an object of the present invention is to provide an electron gun for a cathode ray tube (CRT) that is capable of preventing a degradation of a spot focussed on a screen while having a simple structure.

To achieve these and other advantages and in accordance with the purpose of the present invention, as embodied and broadly described herein, there is provided an electron gun for a CRT having a cathode for discharging electron beams, a first electrode for controlling the electron beams discharged from the cathode, and a second electrode for accelerating the electron beams having passed the first electrode, third, fourth and fifth electrodes sequentially installed in the direction of a screen and serving as a pre-focus lens, in which an electron beam passing hole of the third electrode, an electron beam passing hole of the fourth electrode and an electron beam passing hole of the fifth electrode have different sizes.

To achieve the above object, there is also provided an electron gun for a CRT having a cathode for discharging electron beams, a first electrode for controlling the electron beams discharged from the cathode, and a second electrode for accelerating the electron beams having passed the first electrode, third, fourth and fifth electrodes sequentially installed in the direction of a screen and serving as a pre-focus lens, wherein an electron beam passing hole of the fourth electrode is greater than an electron beam passing hole of the third electrode, and an electron beam passing hole of the fifth electrode is greater than an electron beam passing hole of the fourth electrode.

To achieve the above object, there is also provided an electron gun for a CRT having a cathode for discharging electron beams, a first electrode for controlling the electron beams discharged from the cathode, and a second electrode for accelerating the electron beams having passed the first electrode, third, fourth and fifth electrodes sequentially installed in the direction of a screen and serving as a pre-focus lens, wherein an electron beam passing hole of the fourth electrode is greater than an electron beam passing hole of the third electrode, an electron beam passing hole of the fifth electrode is greater than an electron beam passing hole of the fourth electrode, at least more than one fourth electrode is formed in a plate shape, at least more than two third electrodes are formed in a plate shape, and the fifth electrode is formed in a cylindrical shape.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention

In the drawings:

FIG. 1 is a view showing a construction of an electron gun for a CRT in accordance with a conventional art;

FIG. 2 is a view showing a construction of an electron gun for a CRT in accordance with a first embodiment of the present invention;

FIG. 3 is a conceptual view showing a potential distribution of a pre-focus lens of the electron gun for a CRT in accordance with the present invention;

FIG. 4 is a schematic view showing an optical model of FIG. 3;

FIG. 5 is a view showing a construction of an electron gun for a CRT in accordance with a second embodiment of the present invention;

FIG. 6 is a view showing a construction of an electron gun for a CRT in accordance with a third embodiment of the present invention;

FIG. 7A is a graph showing a current density distribution on a screen without a spherical aberration;

FIG. 7B is a graph showing a current density distribution on a screen with a spherical aberration;

FIG. 8A is a view showing a form of a spot focussed on the screen without a spherical aberration; and

FIG. 8B is a view showing a form of a spot focussed on the screen with a spherical aberration

### DETAILED DESCRIPTION OF THE PREFERRED EMBODIMENTS

Reference will now be made in detail to the preferred embodiments of the present invention, examples of which are illustrated in the accompanying drawings.

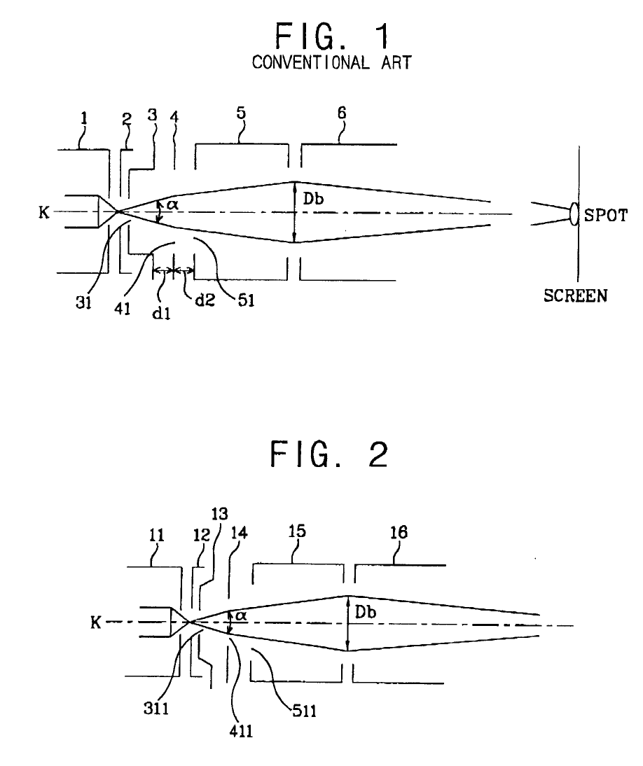

As shown in FIG. 2, similar to the construction of the conventional electron gun for a CRT, an electron gun for a CRT of the present invention also includes: a cathode (K) for discharging electrons, a first electrode 11 for controlling the electron beams discharged from the cathode; a second electrode 12 for accelerating the electron beams passing the first electrode 11; third, fourth and fifth electrodes 13, 14 and 15 for focussing the electron beams; and a sixth electrode 16, an anode, for receiving a high voltage.

But, it is noted in the present invention that the third electrode 13, the fourth electrode 14 and the fifth electrode 15 are installed adjacent to face each other, and electron beam passing holes of the third, fourth and fifth electrodes 13, 14 and 15 have different sizes.

That is, the passing hole 411 of the fourth electrode 14 is greater than the passing hole 311 of the third electrode 13, while the passing hole 511 of the fifth electrode 15 is greater than the passing hole 411 of the fourth electrode 14.

With this construction, the divergence angle (α) of the electron beam and the size of electron beam at the main lens unit can be easily changed compared to the conventional art.

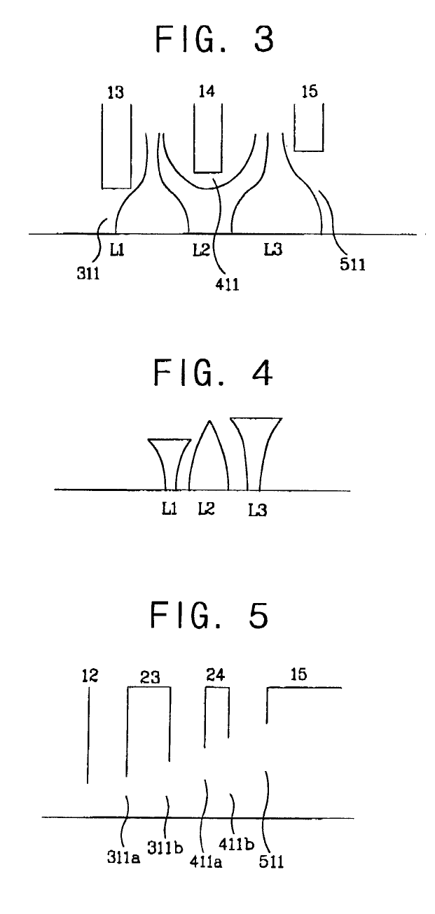

The principles of the present invention will now be described in detail with reference to FIGS. 3 and 4.

As shown in FIG. 3, a lens L1 has a concave form by forming a divergent electrostatic lens formed by the third and fourth electrodes, as a concave lens, an optical lens. A lens L2 has a convex form by forming a focussing electrostatic lens formed by the fourth and fifth electrodes, as a convex lens, an optical lens. A lens L3 has a concave form by forming a divergent electrostatic lens formed by the fourth and fifth electrodes, as a concave lens, an optical lens

With reference to FIG. 3, the passing hole 411 of the fourth electrode 14 is greater than the passing hole 311 of the third electrode 13, and the passing hole 511 of the fifth electrode 15 is greater than the passing hole 411 of the fourth electrode 14.

With this construction, the intensity of the lens L2 is intensified compared with the electron gun of the conventional art, so that the divergence angle (α) of the electron beam to the main lens and the electron beam size (Db) at the main lens can become small.

That is, the reduction in the divergence angle (α) of the electron beam and the size (Db) of the electron beam at the main lens leads to a reduction of the spherical aberration and accordingly the spot on the screen is improved.

If the divergence angle (α) of the electron beam and the size (Db) of electron beam at the main lens fail to come up to an optimum value, the size of the electron beam passing hole 411 of the fourth electrode 14 can be suitably controlled.

That is, if the electron beam passing hole 411 of the fourth electrode 14 is enlarged, the focussing force of the lens L2 is weakened more than the lens L1 and the lens L3, making the divergence angle (α) of the electron beam and the size (Db) of the electron beam at the main lens to be enlarged.

In contrary, if the electron beam passing hole 411 of the fourth electrode 14 is made small, the focussing force of the lens L2 is strengthened more than the lens L1 and the lens L3, making the divergence angle (α) of the electron beam and the size (Db) of the electron beam at the main lens small.

The form of the electron beam passing holes 311 and 411 is not limited to a simple circular form. That is, the electron beam passing hole may be a circular form or a rectangular form.

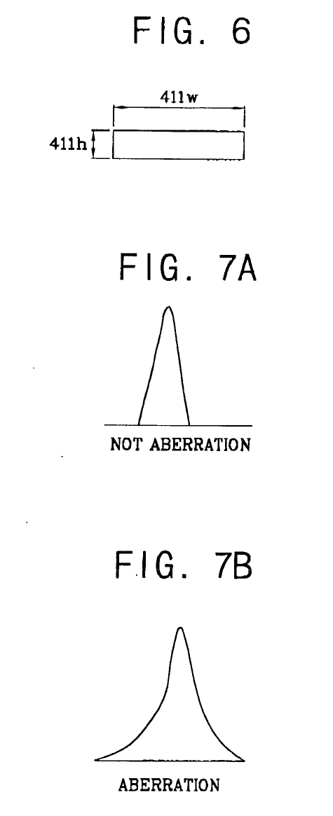

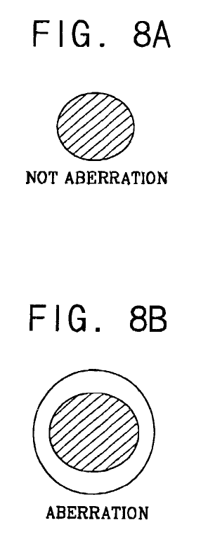

As shown in FIG. 6, if the passing hole 411 of the fourth electrode has a rectangular shape, it is preferred that a vertical length 411h and a horizontal length 411w thereof are different.

The reason is that if the vertical length 411h and the horizontal length 411w of the electron beam passing hole 411 are different, the electron beam divergence angle (α) in the vertical direction and the horizontal direction and the size (Db) of the electron beam of the main lens can be controlled.

An electron gun for a CRT in accordance with a second embodiment of the present invention will now be described with reference to FIG. 5.

Unlike the third and the fourth electrodes 13 and 14 in the plate shape as in the former embodiment of the present invention, the third electrode 13 and the fourth electrode 14 of the second embodiment has a cylindrical shape.

The third electrode 23 includes a first passing hole 311a facing the second electrode 12 and a second passing hole 311b facing the fourth electrode 24.

Preferably, the first passing hole 311a and the second passing hole 311b have different size, and most preferably, the size of the first passing hole 311a is smaller than the size of the second passing hole 311b.

The third electrode 23 can be constructed by combining at least more than two platy electrodes.

The fourth electrode 24 may include the first passing hole 411a facing the third electrode 23 and a second passing hole 411b facing the fifth electrode 15.

Preferably, the third electrodes 13 and 23 and the fifth electrode 15 have the following relation:

(the size of the electron beam passing hole 511 of the fifth electrode×0.1) ≦the size of the electron beam passing hole of the third electrode≦(the size of the electron beam passing hole 511 of the fifth electrode×0.5) (1)

The reason is that if the size of the electron beam passing holes 311, 311a and 311b of the third electrodes 13 and 23 is smaller than (the size of the electron beam passing hole 511 of the fifth electrode×0.1), it is difficulty to assemble an electron gun Meanwhile, if the size of the electron beam passing hole 311 of the third electrodes 13 and 23 is greater than (the size of the electron beam passing hole 511 of the fifth electrode×0.5), the aberration of the pre-focus lens is increased and the size of spot on the screen is accordingly increased.

Preferably, the fourth electrodes 14 and 24 and the fifth electrode 15 have the following relation:

(the size of the electron beam passing hole (511) of the fifth electrode×0.5)≦the size of the electron beam passing hole of the fourth electrode≦the size of the electron beam passing hole 511 of the fifth electrode (2).

The reason is that if the size of the electron beam passing holes 411, 411a and 411b of the fourth electrodes 14 and 24 is smaller than (the size of the electron beam passing hole 511 of the fifth electrode×0.5), the divergence angle (α) is much reduced to diverge from the optimum divergence angle, so that the size of the spot on the screen is increased.

If the size of the electron beam passing holes 411, 411a and 411b of the fourth electrodes 14 and 24 is greater than the electron beam passing hole 511 of the fifth electrode, it is difficult to assembly the electron gun.

As so far described, the electron gun for a CRT of the present invention has many advantages.

That is, for example, a change in the spot size caused by a current change and a focus voltage change can be reduced by facilitating designing the divergence angle of an electron beam made incident on the main lens and the size of the electron beam at the main lens.

Namely, by controlling the size of the electron beam passing hole of the third, the fourth and the fifth electrodes, the divergence angle and the electron beam size are reduced and the spherical aberration is also reduced. Accordingly, a degradation of the spot focussed on the screen can be effectively prevented.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. An electron gun for a CRT having a cathode for discharging electron beams, a first electrode for controlling the electron beams discharged from the cathode, and a second electrode for accelerating the electron beams having passed the first electrode, third, fourth and fifth electrodes sequentially installed in the direction of a screen and serving as a pre-focus lens,
wherein an electron beam passing hole of the third electrode, an electron beam passing hole of the fourth electrode and an electron beam passing hole of the fifth electrode have different sizes.

2. The electron gun of claim 1, wherein the size of the electron beam passing hole of the third electrode and the size of the electron beam passing hole of the fourth electrode are smaller than the size of the electron beam passing hole of the fifth electrode.

3. The electron gun of claim 2, wherein the size of the electron beam passing hole of the third electrode is smaller than the electron beam passing hole of the fourth electrode.

4. The electron gun of claim 1, wherein the electron beam passing hole of the fourth electrode has a rectangular shape and its vertical length and horizontal length are different.

5. The electron gun of claim 1, wherein the third electrode includes a first passing hole facing the second electrode and a second passing hole facing the fourth electrode.

6. The electron gun of claim 5, wherein the size of the first passing hole and the size of the second passing hole are different.

7. The electron gun of claim 6, wherein the size of the first passing hole is smaller than the size of the second passing hole.

8. The electron gun of claim 1, wherein the relation between the electron beam passing hole of the third electrode and the electron beam passing hole of the fifth electrode satisfies the following formula:
the electron beam passing hole of the fifth electrode×0.1≦the electron beam passing hole of the third electrode≦the electron beam passing hole of the fifth electrode×0.5

9. The electron gun of claim 1, wherein the relation between the electron beam passing hole of the fourth electrode and the electron beam passing hole of the fifth electrode satisfies the following formula.
the electron beam passing hole of the fifth electrode×0.5≦the electron beam passing hole of the fourth electrode≦the electron beam passing hole of the fifth electrode

10. An electron gun for a CRT having a cathode for discharging electron beams, a first electrode for controlling the electron beams discharged from the cathode, and a second electrode for accelerating the electron beams having passed the first electrode, third, fourth and fifth electrodes sequentially installed in the direction of a screen and serving as a pre-focus lens,
wherein an electron beam passing hole of the fourth electrode is greater than an electron beam passing hole of the third electrode, and an electron beam passing hole of the fifth electrode is greater than an electron beam passing hole of the fourth electrode.

11. The electron gun of claim 10, wherein the electron beam passing hole of the fourth electrode has a rectangular shape and its vertical length and horizontal length are different.

12. The electron gun of claim 10, wherein the third electrode includes a first passing hole facing the second electrode and a second passing hole facing the fourth electrode.

13. The electron gun of claim 12, wherein the size of the first passing hole and the size of the second passing hole are different.

14. The electron gun of claim 12, wherein the size of the first passing hole is smaller than the size of the second passing hole.

15. The electron gun of claim 10, wherein the relation between the electron beam passing hole of the third electrode and the electron beam passing hole of the fifth electrode satisfies the following formula:
the electron beam passing hole of the fifth electrode×0.1≦the electron beam passing hole of the third electrode≦the electron beam passing hole of the fifth electrode×0.5

16. The electron gun of claim 10, wherein the relation between the electron beam passing hole of the fourth electrode and the electron beam passing hole of the fifth electrode satisfies the following formula:
the electron beam passing hole of the fifth electrode×0.5≦the electron beam passing hole of the fourth electrode≦the electron beam passing hole of the fifth electrode.

17. An electron gun for a CRT having a cathode for discharging electron beams, a first electrode for controlling the electron beams discharged from the cathode, and a second electrode for accelerating the electron beams having passed the first electrode, third, fourth and fifth electrodes sequentially installed in the direction of a screen and serving as a pre-focus lens,
wherein an electron beam passing hole of the fourth electrode is greater than an electron beam passing hole of the third electrode, an electron beam passing hole of the fifth electrode is greater than an electron beam passing hole of the fourth electrode at least more than one fourth electrode is formed in a plate shape, at least more than two third electrodes are formed in a plate shape, and the fifth electrode is formed in a cylindrical shape.
